(19) United States
(12) Patent Application Publication
(10) Pub. No.: US 2009/0059868 A1
(43) Pub. Date: Mar. 5, 2009

(54) Cell Base Station Radio Frequency Channel Selection

(75) Inventors: Vijayasimman Rajasimman, Richardson, TX (US); Nivedan Thadasina, Allen, TX (US); John C. Jubin, Richardson, TX (US)

Correspondence Address: DOCKET CLERK, P.O. DRAWER 800889, DALLAS, TX, 75380, US

(73) Assignee: SAMSUNG ELECTRONICS CO., LTD., Gyeonggi-do (KR)

(21) Appl. No.: 11/848,722

(22) Filed: Aug. 31, 2007

(51) Int. Cl. H04Q 7/22

(52) U.S. Cl. 370/332

(57) ABSTRACT

A code division multiple access telecommunications network including an underlay base station in a private premises and a plurality of overlay macro base stations. The underlay base station includes a GPS receiver and a mobile unit receiver. The underlay base station uses its geographic location to obtain information identifying base stations within a preselected distance of the underlay base station. It uses the mobile receiver to measure signal strength of the base stations. It automatically selects as an operating frequency a channel dedicated to underlay stations or an unused channel allocated for macro base stations or a macro base station frequency which results in minimum interference. The mobile unit receiver may be used to identify the frequency with lowest signal level at the underlay station.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure relates to cellular networks and more particularly to code division multiple access, CDMA, base stations which support self configuration of RF channels.

Inadequate coverage is a persistent problem in the quality of service of any wireless network. Natural and man-made obstacles frequently create radio frequency (RF) holes, i.e. areas of low or no RF signal, in the coverage area of a wireless network. Voice and data call connections are frequently dropped when a wireless terminal, such as a cell phone or a similar mobile station, enters an RF hole. Typical areas in which RF holes occur include homes, apartments, underground tunnels and office buildings. A private “home base station” (HBS) has been proposed for use to fill an RF hole in a home for home mobile units or mobile stations.

Conventional public CDMA cellular systems include a number of macro base stations (MBSs) arranged to provide service in contiguous cells. As mobile units move between cells, the mobile units are handed off between macro base stations to maintain continuous service. Each MBS has operating channels at one or more frequencies for supplying voice services to mobile units, MUs, in its cell. Each MBS also has beacon channels operating at frequencies of nearby MBSs to facilitate the hand off of MUs moving from nearby cells into its cell area. The allocation of frequencies for operating and beacon channels of MBSs requires manual operational procedures by trained technicians to prevent interference and make maximum use of the available channels. These manual procedures are expensive and time consuming, but are a relatively small part of the overall cost of installing an MBS.

### SUMMARY

In a CDMA telecommunication network, an underlay base station includes a GPS receiver providing geographic location of the underlay base station. The underlay base station transmits the location information to a server having a database of base stations in the network. The server returns identifying information for overlay macro base stations within a preselected distance of the underlay base station including locations and operating frequencies used by the overlay macro base stations. The server also provides a list of allowed operational frequencies, based on the particular vendor's spectrum information, that the underlay base station may use in it's current location.

In an embodiment, the underlay base station includes a mobile unit receiver. The receiver is operated to receive and measure the strength of signals from the identified base stations. The measured signal strength may be used to select an operating frequency which will cause minimum interference with the identified base stations.

In an embodiment, the underlay base station includes a hopping beacon. The underlay base station may select a plurality of operating frequencies of identified macro base stations as frequencies sequentially transmitted as the hopping beacons.

In an embodiment, the underlay base station registers mobile units which are authorized to receive service from the underlay base station and stores identification numbers for each authorized mobile unit. It uses the registration numbers to determine which macro base station frequencies are used by the authorized mobile units and selects a plurality of such frequencies as frequencies sequentially transmitted by the hopping beacon.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a general diagram of a CDMA cellular system overlaying a home base station.

FIG. 2 is a block diagram of a home base station.

FIG. 3 is a flow diagram of an embodiment of a method for selected operating channels.

FIG. 4 is a flow diagram of an embodiment of a method for selecting beacon channels.

FIG. 5 illustrates an exemplary general purpose computer system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

A “home base station” (HBS) can be used for various reasons including to fill an RF hole in a home, apartment, office, or other structure for mobile devices, mobile phones, computers, or other wireless devices or mobile stations, referred to herein as home mobile units, HMUs, normally operated within the structure. An HBS is generally speaking a very small cell base station designed to support a small number, e.g. two to four, of HMUs in or near a structure such as a private residence, business office or the like. The number of HBSs is therefore expected to be much larger than the number of MBSs. An HBS generally may not provide service to foreign mobile units, FMUs, which are served by macro-network base stations, and may be programmed, for example, to allow only registered HMUs to be served by the HBS. The term “home” is used herein because the HBS was initially conceived for use in private residences, but is not intended to limit use to either residences or to privately owned structures. For example, an HBS may be used to provide mobile service to individuals working in a private building or a government building or facility.

An HBS should provide the normal mobile telephone services to an HMU much like a MBS. Each HBS must have an operating channel for providing normal voice service. Each HBS needs to have one or more beacon channels, like a MBS, to enable handoff of mobile units from a MBS to the HBS when the HMUs move into range of the HBS, e.g. move inside a private residence or other structure served by the HBS.

The proposed HBSs must also have an RF channel to provide voice service and must have beacon channels to facilitate handoff from nearby cells which overlay the HBS. It is expected that HBSs will be inexpensive and a large number will be installed in private premises. The individual users expect to be able to plug in an HBS and use it without having to schedule and pay for a technician visit. Thus, manual procedures used for configuring RF channels for MBSs are inconsistent with HBSs.

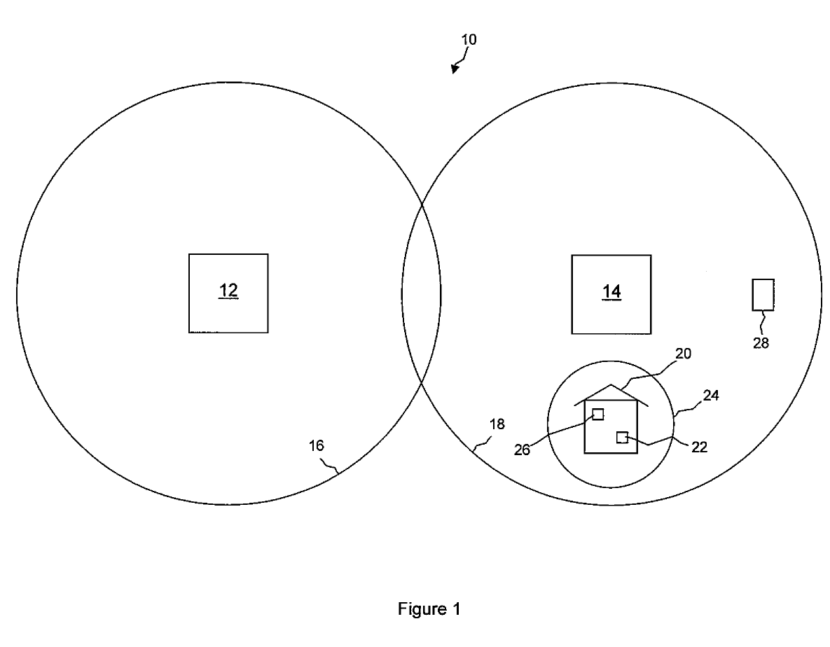

FIG. 1 illustrates a CDMA cellular system 10 configured according to an embodiment. The system 10 includes a large number of macro base stations, MBSs, of which two MBSs 12 and 14 are shown in FIG. 1. MBS 12 serves a cell indicated by the circle 16 and MBS 14 serves a contiguous cell indicated by the circle 18. It is understood that cells 16, 18 may have other shapes and may be divided into sectors depending on antenna configurations and other factors. A private residence 20 is located within the cell 18. Within the residence 20 is located a home base station, HBS, 22. The HBS 22 serves a small cell including the area enclosed by the residence 20 and possibly a small area surrounding the residence 20 as indicated by the circle 24, again with the understanding that the cell 24 may have other shapes, and may not completely enclose or provide service to the entire building depending upon the size and configuration of the structure.

A home mobile unit, HMU, 26 is shown within the residence 20 and therefore within the cell 24 and is served by the HBS 22. A foreign mobile unit, FMU, 28 is shown within the cell area 18, but outside the residence 20, and is served by the MBS 14. In this configuration, the cell 24 is considered an underlay cell relative to the cell 18 and the cell 18 is considered an overlay cell relative to the cell 24. The cell 16 and other cells may also be considered to be overlay cells relative to cell 24, depending on distance and signal strength.

Mobile units 26 and 28 may be any suitable wireless devices (e.g., conventional cell phones, PCS handsets, personal digital assistant (PDA) handsets, portable computers, telemetry devices, etc.) that are capable of communicating with base stations 12, 14, 22 via wireless links. It should be understood that the use of the term “mobile unit” in the claims and in the description below is intended to encompass both truly mobile devices (e.g., cell phones, wireless laptops) and stationary wireless terminals (e.g., a machine monitor with wireless capability). In the disclosed embodiments, the HMU 26 and FMU 28 may be substantially similar devices. That is, no modifications to a MU may be needed for the MU to operate as an HMU. The HBS may distinguish between an HMU and a FMU based on the identification numbers of the MUs. In one embodiment, the HBS 22 is programmed to provide service only to MUs which have been registered with the HBS 22 and thereby become HMUs.

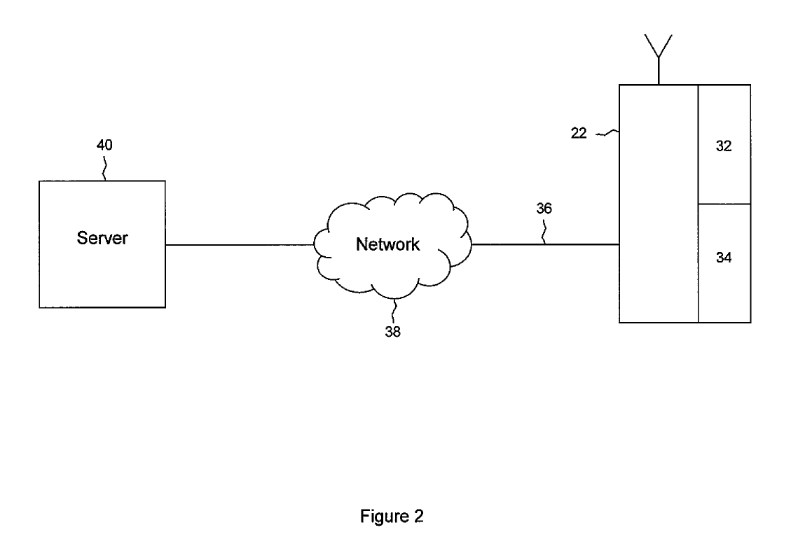

FIG. 2 illustrates more details of an embodiment of a HBS 22. The HBS 22 includes functional elements of a conventional CDMA base station, such as those used in MBSs 12 and 14, as needed to support service for MUs. The HBS 22 includes an antenna 30 for communicating with MUs. HBS 22 includes a global positioning satellite, GPS, receiver 32 for receiving position and timing information. In addition, HBS 22 includes a mobile module, or over the air receiver, 34 which provides the functionality of a mobile unit, such as MUs 26 and 28.

The HBS 22 has a connection 36 to a network 38, such as but not limited to the Internet. The connection 36 may be through, for example, an ISP (Internet Service Provider) used by the occupants of the residence 20. The connection 36 may be any conventional IP (Internet Protocol) or other connection, but preferably is a high speed connection such as cable, DSL (digital subscriber line) or an optical fiber system. The HBS 22 connects through the connection 36 to a server 40, which for example may be operated by the cellular telephone service provider which provided the HBS 22. In this embodiment, the server 40 stores information identifying the MBSs and HBSs operated by the cellular telephone service provider.

The HBS 22 may not be connected to the same network as the MBSs 12 and 14, and may be not controlled by the same base station controller as the MBSs 12 and 14. The HBS 22 includes it own base station controller functionality. In conventional cell systems which include MBSs overlaying smaller underlay cells, both the overlay and underlay base stations are controlled by the same base station controller. Such systems can use a single pilot frequency to controlling handoff, because the single base station controller can instruct all MUs being served to monitor a single pilot frequency, even if they are being served by a traffic channel at another frequency.

Since HBS 22 in the present embodiment is not controlled by the same base station controller as the MBSs 12 and 14, its beacon signal may provide a hopping pilot signal. The hopping pilot transmits at a plurality of frequencies and continuously cycles through the frequencies. The pilot needs to be transmitted at many, or perhaps all, frequencies of nearby MBSs which may be serving HMUs that may enter the residence 20 and desirably be handed off to the HBS 22. Thus in the FIG. 1 scenario, the HBS 22 beacon may provide a pilot frequency corresponding to MBS 14, since it can be expected that the HMU 26 may be served by MBS 14 when it moves from outside to inside cell 24. However, it is very possible that HMU 26 passed through cell 16 and is still receiving service from MBS 12 when it enters cell 24. It is also possible that cell 18 may have multiple traffic channel frequencies and an HMU may be operating at any one of them when it enters the residence 20. In any case, the HBS 22 beacon preferably transmits its pilot signal at all frequencies at which an HMU may be operating when it enters the cell 24. It would be possible to provide multiple beacon transmitters to simultaneously transmit the multiple pilot frequencies, but this would increase the cost of a HBS. A hopping pilot is preferred to minimize the cost of the HBS 22.

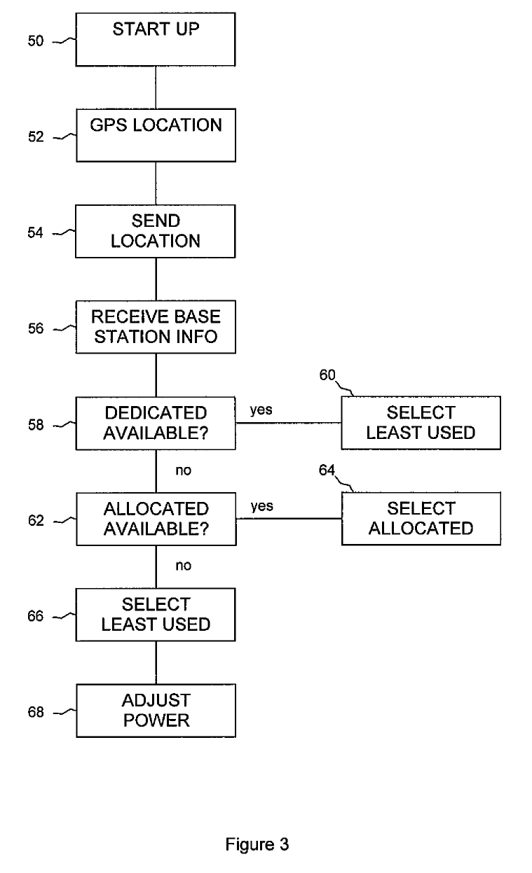

Operation of an embodiment for autonomously or automatically selecting an operating channel for HBS 22 will be described with reference to the flow chart of FIG. 3. At step 50, the HBS 22 is started, e.g. the system is installed and power is turned on. The startup step may be repeated whenever power is restored to HBS after a power outage or upon another restart event, e.g. manual activation of a reset or restart button or receipt of a restart command from a remote server. The HBS 22 may be programmed to automatically restart or recheck or audit on a weekly, daily, etc. basis or more often and each such event may be considered a startup for purposes of step 50.

At step 52, the HBS 22 uses the GPS unit 32 to determine the location, i.e. latitude and longitude of the HBS 22. At step 54, the HBS 22 transmits the GPS location information to the server 40. The server 40 is operated by the telephone service provider which may have provided the HBS 22 to an end user, e.g. an occupant of the residence 20. The server 40 stores information identifying all MBSs and HBSs in the service providers cellular network. The server 40 determines which BSs are within a preselected distance, e.g. five or ten kilometers, from the location of the HBS 22. In one embodiment, the preselected distance may be set to a default value of one hundred kilometers. The server 40 then sends the identifying information for the BSs back to the HBS 22 at step 56. The identifying information, for example, includes the distance to each BS, the switch ID of the mobile switching center serving each MBS, the operating RF channel or channels, the beacon channel or channels, and PN (pseudonoise) codes for each MBS, and other information.

Server 40 also stores information identifying channels which the telephone service provider is licensed to use in the area of the HBS 22. Some of these channels may be dedicated for use only by HBSs and are referred to herein as dedicated channels. Other channels by allocated primarily for use by MBSs, and are referred to herein as allocated channels. This information is also provided to the HBS 22 at step 56.

At step 58, the HBS 22 determines whether the server 40 identified any dedicated channels. If dedicated channels are available, then at step 60 the HBS 22 selects a dedicated channel as its operating channel. The HBS 22 will select the least used dedicated channel. The least used channel may be determined simply by the information from server 40 which includes the identification and location of other HBSs and their operating channels or alternatively the HBS may report the neighbor HBS usage (using its mobile functionality) back to the server and server can decide the best channel based on the neighbor HBS usage report and also based on a distance check method. In the distance check method, the server can automatically calculate the other closest neighbor HBS and determine the channel usage accordingly. Alternatively, the HBS 22 may activate its mobile function 34 and actually measure signal strength, if any, detected on the dedicated channels. A dedicated channel with no detectable signal, or the channel with the weakest signal, may be selected as the operating channel.

If at step 58 it is found that there are no dedicated channels, then at step 62 the HBS 22 determines if any allocated channels are available. An allocated channel may be considered to be available if no nearby MBS is using the particular allocated channel. This can be determined from the information identifying locations and operating channels of nearby MBSs. If an allocated channel is available, then at step 64, the HBS 22 may select the allocated channel as its operating frequency.

If at step 58, it is determined that there is no available, i.e. unused, allocated channel, then at step 66 the HBS 22 selects the least used allocated channel as its operating frequency. The determination of least used may again be based simply on the locations of MBSs and operating channel information received from the server 40. For example, with reference to FIG. 1, the HBS 22 would not select a channel used by MBS 14 which is the closest MBS, but may select an operating channel from MBS 12 which is farther away. The mobile function 34 may again be used to measure the strength of signals received from nearby MBSs to determine the weakest detectable allocated channel, and HBS 22 may select the weakest signal, since that would minimize interference. If HBS 22 selects an allocated channel, it may limit its operating power at step 68 to minimize interference with nearby MBSs operating on the same frequency.

As noted above, the HBS 22 needs to also provide beacon signals at all frequencies at which a HMU entering the premises 20 may be operating in order to facilitate handoff to the HBS 22. MBSs 12 and 14 may each have multiple operating frequencies. The number of frequencies may exceed the capacity of the hopping beacon used in the HBS 22. The hopping beacon is generally limited to a small number of frequencies, e.g. five frequencies.

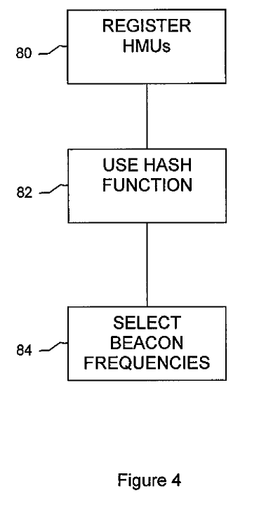

FIG. 4 illustrates a process used by HBS 22 to limit the number of beacon channels it needs to transmit. At step 80, the HBS 22 registers the HMUs which are authorized to be served by the HBS 22. As part of the registration process, the HBS 22 stores the mobile identification number of each HMU. At step 82 the HBS 22 applies a standard hash function to each registered identification number. The hash function is a standard function used in CDMA systems to balance loads among multiple operating channels used by any given MBS. The identification numbers are essentially random and the hash function selects a particular operating frequency for each MU in each cell based on identification numbers. Since the HBS 22 is intended to serve no more than about five HMUs, this process should identify no more than five beacon frequencies. At step 84, the HBS 22 selects the identified frequencies as the beacon channels for the hopping beacon.

The HBS 22 may dynamically change the selected beacon frequencies as the authorized HMUs enter and leave the premises 30. When an authorized HMU is being provided service by HBS 22, the beacon channel selected for it may be deleted from those transmitted by the hopping beacon. When all authorized HMUs are being provided service by the HBS 22, it may turn off the beacon signal completely since there would be no other MU authorized to handoff to the HBS 22.

While the disclosed embodiments are directed to a base station in a private residence, it is apparent that the present disclosure is equally applicable to other embodiments. The HBS 22 may be used in other locations such as business premises, schools, libraries, etc. Any enclosed structure is likely to generate an RF hole with poor service from the MBSs and service may be improved by installation of an HBS in the structure.

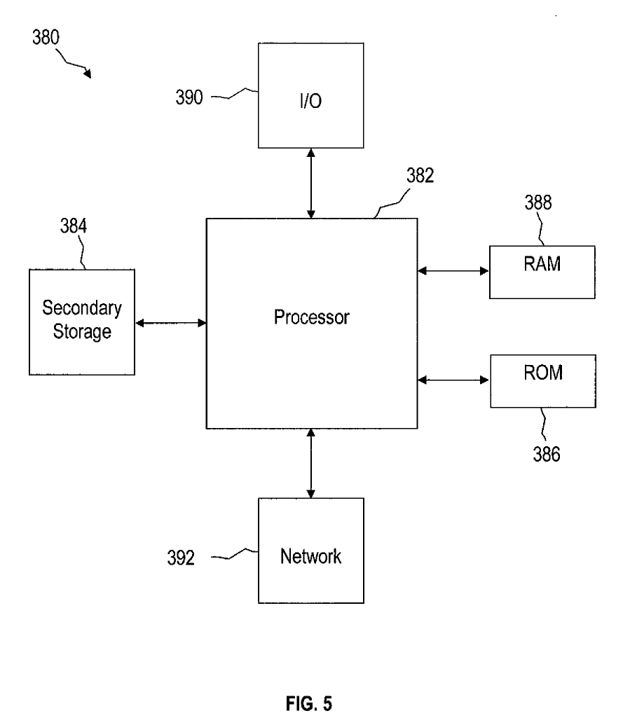

The system described above may be implemented on any general-purpose computer with sufficient processing power, memory resources, and network throughput capability to handle the necessary workload placed upon it. FIG. 5 illustrates a typical, general-purpose computer system suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A code division multiple access underlay base station, comprising:
apparatus automatically obtaining information identifying operating frequencies used by, and locations of, base stations within a preselected distance of the underlay base station and automatically selecting an operating frequency for the underlay base station.

2. The code division multiple access underlay base station of claim 1, further comprising:
cellular receiver apparatus measuring signal level of each of the base stations within the preselected distance; and
apparatus selecting the frequency having the lowest signal level as the operating frequency for the underlay base station.

3. The code division multiple access underlay base station of claim 1, further comprising:
a global positioning satellite receiver detecting the location of the underlay base station; and
apparatus transmitting the location to a server storing information identifying base stations and receiving from the server information identifying locations of, and operating channels used by, base stations within the preselected distance of the underlay base station.

4. The code division multiple access underlay base station of claim 1, wherein the underlay base station is located in a private premises.

5. The code division multiple access underlay base station of claim 1, further comprising apparatus automatically obtaining information identifying operating frequencies dedicated for use by underlay base stations and automatically selecting the least used of the dedicated frequencies as an operating frequency for the underlay base station.

6. The code division multiple access underlay base station of claim 5, further comprising:
cellular receiver apparatus measuring signal level of each underlay base station within the preselected distance; and
apparatus selecting the dedicated frequency having the lowest signal level as the operating frequency for the underlay base station.

7. The code division multiple access underlay base station of claim 1, further comprising:
a hopping beacon adapted to sequentially transmit a plurality of beacon frequencies; and
apparatus selecting operating frequencies used by macro base stations within a preselected distance of the underlay base station as the beacon frequencies.

8. The code division multiple access underlay base station of claim 1, further comprising:
apparatus receiving and storing identification numbers of a plurality of mobile units authorized to be served by the underlay base station;
apparatus using the identification numbers to determine which operating frequencies used by macro base stations within a preselected distance of the underlay base station will be used by the mobile units authorized to be served by the underlay; and
apparatus selecting the frequencies used by the mobile units authorized to be served by the underlay as the beacon frequencies.

9. A method for an underlay base station in a code division multiple access telecommunications network, comprising:
providing the underlay base station with global positioning satellite receiver apparatus;
operating the global positioning satellite receiver apparatus to determine the geographic location of the underlay base station;
transmitting the location to a server containing information identifying base stations within a preselected distance of the location;
receiving from the server information identifying locations of, and operating frequencies used by, the base stations within the preselected distance from the underlay base station; and,
automatically selecting an operating frequency for the underlay base station which has the least interference with frequencies used by the base stations within the preselected distance from the underlay base station.

10. The method of claim 9, further comprising:
providing the underlay base station with mobile unit receiver apparatus; and
operating the mobile unit receiver apparatus to receive and determine the strength of the signals from base stations within the preselected distance from the underlay base station; and
selecting the operating frequency of the weakest signal from the base stations within the preselected distance from the underlay base station as the operating frequency of the underlay base station.

11. The method of claim 9, wherein the server stores information identifying operating frequencies dedicated to underlay base stations, further comprising;
receiving from the server the information identifying operating frequencies dedicated to underlay base stations; and
automatically selecting the operating frequency dedicated to underlay base stations which has the least interference with frequencies used by other underlay base stations within the preselected distance from the underlay base station as the operating frequency of the underlay base station.

12. The method of claim 11, further comprising:
providing the underlay base station with mobile unit receiver apparatus;
operating the mobile unit receiver apparatus to receive and determine the strength of signals from other underlay base stations within the preselected distance from the underlay base station; and
selecting the operating frequency of the weakest signal from the underlay base stations within the preselected distance from the underlay base station an the operating frequency of the underlay base station.

13. The method of claim 9, further comprising:
providing the underlay base station with a hopping beacon transmitter; and
automatically selecting a plurality of frequencies from the operating frequencies used by the base stations within the preselected distance from the underlay base station as frequencies transmitted by the hopping beacon transmitter.

14. The method of claim 13, further comprising:
receiving from and storing identification numbers from a plurality of mobile units authorized to receive service from the underlay base station;
using the stored identification numbers to determine macro base station frequencies which are used by the mobile units authorized to receive service from the underlay base station; and,
automatically selecting a plurality of frequencies from the macro base station frequencies which are used by the mobile units authorized to receive service from the underlay base station as frequencies transmitted by the hopping beacon transmitter.

15. The method of claim 9, further comprising installing the underlay base station in a private premises.

16. The method of claim 9, further comprising installing the underlay base station in a residence.

17. The method of claim 9, wherein the underlay base station communicates with the server via a wired connection.

18. The method of claim 17, wherein the underlay base station communicates with the server via a high speed connection selected from a group consisting of cable, DSL (digital subscriber line), and a optical fiber connections.

19. The method of claim 9, further comprising an overlay cell overlaying the underlay base station cell.
